(19) United States
(12) Patent Application Publication
(10) Pub. No.: US 2026/0170254 A1
(43) Pub. Date: Jun. 18, 2026

(54) AUTOMATED USER FEEDBACK ANALYSIS USING LARGE LANGUAGE MODELS

(71) Applicant: INTUIT INC., Mountain View, CA (US)

(72) Inventors: Natalie BAR ELIYAHU, Azor (IL); Shon MENDELSON, Tel Aviv (IL); Hadar LACKRITZ, Tel-Aviv (IL); Hadas BAUMER, Tel-Aviv (IL); Gal ELGAVISH, Tel-Aviv (IL); Lior TABORI, Tel-Aviv (IL)

(21) Appl. No.: 18/984,261

(22) Filed: Dec. 17, 2024

(51) Int. Cl. G06F 40/30; G06F 40/279; G06F 40/40

(52) U.S. Cl. CPC G06F 40/30; G06F 40/279; G06F 40/40

(57) ABSTRACT

Aspects of the present disclosure relate to automated feedback analysis. Embodiments include receiving a set of user feedback items. Embodiments further include extracting, using an extraction machine learning model, one or more topics from the set of feedback items. Embodiments further include generating, using a sentiment analysis model, a score for each respective feedback item of the set of feedback items indicating a level of user satisfaction for the respective feedback item. Embodiments further include generating an aggregate score for each topic of the one or more topics based on the scores for the feedback items and matching each feedback item of the set of feedback items to a respective topic of the one or more topics using a matching machine learning model.

### INTRODUCTION

Aspects of the present disclosure relate to techniques for automatically analyzing feedback received from users. In particular, techniques described herein involve using a machine learning model to extract topics from a set of user feedback items, mapping the feedback items to extracted topics, and then determining a level of satisfaction for each topic based on the sentiment of each feedback item.

### BACKGROUND

Every year, millions of people, businesses, and organizations around the world rely on user feedback for evaluating the performance of systems. For example, the developers of a software application may collect natural language feedback from users of the software application, and changes may be made to the software application based on the feedback.

However, for systems with a large amount of users, a vast amount of feedback items may be received each day. Manually analyzing massive volumes of feedback each day to track user satisfaction and identify issues within a system may be impractical. For example, the users may provide feedback much faster than a team of developers can sort through the feedback. Attempts to automate the feedback analysis process may involve collecting feedback in the form of answers to multiple choice questions, thumbs up/thumbs down indicators, and/or the like. However, the information provided by such feedback may fail to accurately represent user satisfaction levels with a sufficient level of detail. For example, answers to a set of multiple choice questions may fail to capture specific reasons for user satisfaction/dissatisfaction. As a result, causes of user dissatisfaction may not be discovered and addressed, while aspects of a system that satisfy users may be overlooked and not further developed and implemented.

Thus, there is a need in the art for improved techniques of automatically analyzing feedback received from users.

### BRIEF SUMMARY

Certain embodiments provide a method of automated feedback analysis. The method generally includes: receiving a set of user feedback items; extracting, using an extraction machine learning model, one or more topics from the set of feedback items; generating, using a sentiment analysis model, a score for each respective feedback item of the set of feedback items indicating a level of user satisfaction for the respective feedback item; and generating an aggregate score for each topic of the one or more topics based on: the scores for the feedback items; and matching each feedback item of the set of feedback items to a respective topic of the one or more topics using a matching machine learning model.

Certain embodiments provide a method of automated feedback analysis. The method generally includes: receiving a set of user feedback items; providing the set of user feedback items to an extraction machine learning model, wherein the extraction machine learning model is configured to generate a particular output that indicates topics associated with the set of user feedback items; generating, using a sentiment analysis model, a score for each respective feedback item of the set of feedback items indicating a level of user satisfaction for the respective feedback item; providing the set of feedback items and the indicated topics as input to a matching machine learning model that is configured to generate a given output that indicates a topic to which each feedback item of the set of feedback items belongs; and generating an aggregate score for each topic of the indicated topics based on: the scores for the feedback items; and the given output.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated feedback analysis.

FIG. 2 depicts an additional example of computing components related to automated feedback analysis.

FIG. 3 depicts an example feedback-to-topic mapping according to certain embodiments.

FIG. 4 depicts example operations related to automated feedback analysis.

FIG. 5 depicts additional example operations related to automated feedback analysis.

FIG. 6 depicts an example of a processing system for automated feedback analysis.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated feedback analysis.

According to certain embodiments, a set of user feedback items may be received. For example, the feedback items may be natural language feedback submitted by users of a system. An extraction machine learning model (e.g., a large language model, or LLM) may be used to extract topics from the feedback items. As an example, if several of the feedback items relate to a feature of a software application, one of the extracted topics may relate to this feature. A sentiment analysis model may be used to generate a score that indicates the level of user satisfaction for each feedback item. A matching machine learning model may be used to match each feedback item to a topic. For example, if a user provides feedback relating to a feature of a software application, this feedback may be matched with a topic that relates to the feature. Then, a satisfaction score for each topic may be generated based on the satisfaction scores for the feedback items. For example, the satisfaction score for a topic may be an aggregation of the satisfaction scores for each feedback item that was matched with the topic.

In some embodiments, newly-generated topics may be compared to existing topics to determine whether a newly-generated topic matches an existing topic. If a historical topic matches a newly-generated topic, the historical topic (e.g., a topic from a previous day) and the newly-generated topic may be merged to create time series data that allows for tracking trends in user satisfaction over time.

Embodiments of the present disclosure provide numerous technical and practical effects and benefits. For example, by generating a sentiment score for feedback items and using machine learning models to extract topics from the feedback items and map the feedback items to the extracted topics, techniques disclosed herein allow for accurate automated analysis of user feedback on a large scale. As a result, natural language feedback, which was previously incompatible with automated analysis techniques, may be automatically analyzed in a manner that was previously only possible for non-natural-language feedback.

### Example of Computing Components Related to Automated Feedback Analysis

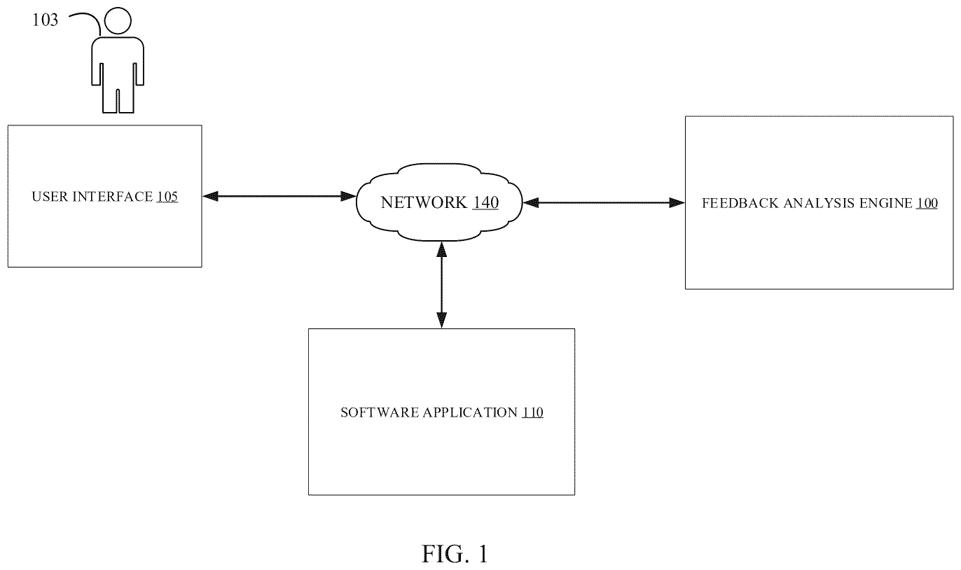

FIG. 1 depicts an example of computing components related to automated feedback analysis.

A user 103 may interact with a computing environment via a user interface 105 associated with a computing device. The computing environment may, for example, comprise a software application 110. The user 103 may provide feedback via the user interface 105. The feedback may generally be any type of feedback. For example, the feedback may be given with respect to the software application 110, or with respect to other systems, services, businesses, and/or the like.

The software application 110 may use feedback analysis engine 100 to analyze the feedback provided by the user 103. For example, the feedback analysis engine 100 may be used to analyze trends in user satisfaction based on the feedback, identify topics that cause high levels of user satisfaction/dissatisfaction, evaluate new features (e.g., features added to software application 110) based on user feedback, and/or the like.

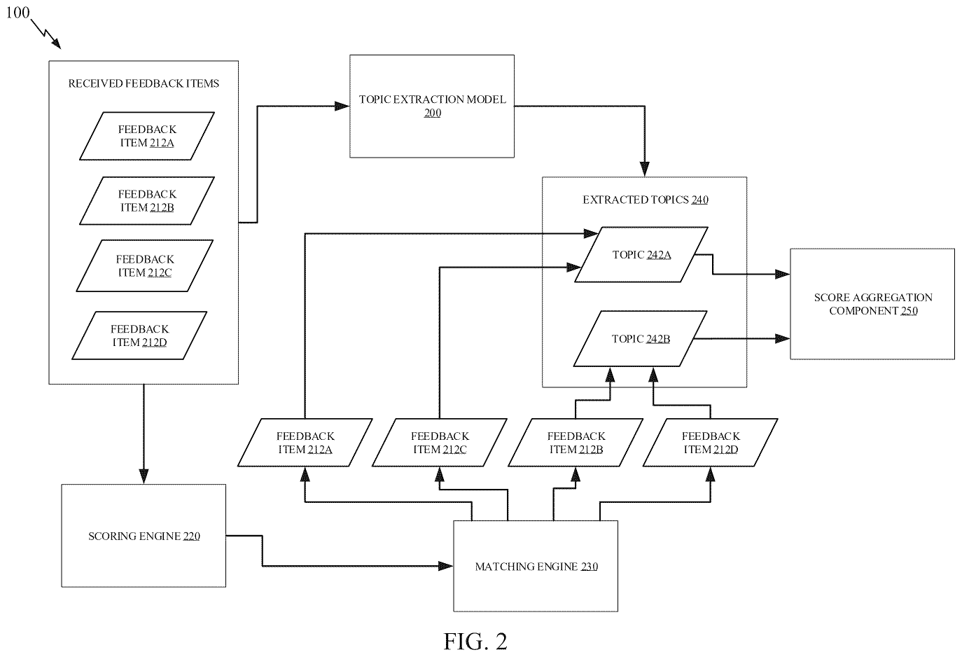

FIG. 2 depicts an additional example of computing components related to automated feedback analysis. In particular, FIG. 2 depicts example functionality of feedback analysis engine 100 of FIG. 1.

A set of feedback items 212A-D may be received. The feedback items 212A-D may comprise natural language feedback provided by users (e.g., users of a software application, system, service, and/or the like). As an example, the feedback items 212A-D may comprise user feedback that was provided with respect to a new feature of a software application (e.g., feedback item 212B may comprise the text “I hate the new feature,” while feedback item 212D may comprise the text “I prefer the new feature to the old feature”). As another example, the feedback items 212A-D may comprise user feedback that was provided with respect to a business such as a restaurant (e.g., feedback item 212B may comprise the text “the appetizers are overpriced”).

The feedback items 212A-D may be provided as part of an input to topic extraction model 200. Topic extraction model 200 may comprise a machine learning model, such as a large language model (LLM) that is trained and/or otherwise configured to extract topics from received feedback items. As an example, topics for feedback regarding a software application may include a new feature of the software application or the layout of the software application. As another example, topics for feedback regarding a business may include the responsiveness of the customer support, the quality of goods/services provided, and/or the like. When provided with the feedback items 212A-D, the topic extraction model 200 may generate an output that comprises extracted topics 240 for the feedback items 212A-D.

The topic extraction model 200 may be trained based on supervised, unsupervised or semi-supervised learning techniques. Supervised learning techniques generally involve providing training inputs to a machine learning model. The machine learning model processes the training inputs and outputs predictions based on the training inputs. The predictions are compared to known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Model parameters adjusted during training may include, for example, hyperparameters, values related to numbers of iterations, weights, functions used by nodes to calculate scores, level of randomness, and/or the like. In some embodiments, validation and testing are also performed for a machine learning model, such as based on validation data and test data, as is known in the art. It is noted that “training” as used herein may refer to initial training, re-training, and/or fine tuning of a machine learning model, such as topic extraction model 200, scoring engine 220, matching engine 230, and/or other machine learning models described herein.

A supervised learning process for the topic extraction model 200 may comprise providing a training input to the topic extraction model 200. The training input may comprise a set of feedback items. A training output may comprise a ground truth list of topics for the feedback items. The training input may be provided to the topic extraction model 200, and the topic extraction model 200 may be used to generate a list of topics for the feedback items. Parameters of the topic extraction model 200 may be iteratively adjusted based on a variance between the training output and the topics generated by the topic extraction model 200 (e.g., until the output of the topic extraction model 200 matches the training output). In certain embodiments, topic extraction model 200 is also or alternatively trained more generally on a broad training data set of natural language data to understand patterns in natural language text, as is known in the art.

A scoring engine 220 may be used to generate scores (e.g., normalized scores) for the feedback items 212A-D. The scores may indicate a level of user satisfaction associated with a feedback item 212 (e.g., a high score may indicate a high level of satisfaction and a low score may indicate a low level of satisfaction, or vice versa). The scoring engine 220 may comprise a machine learning model that has been trained to output a sentiment score for feedback items 212. The machine learning model may be trained through a supervised learning process comprising providing a training item to the model, receiving a score from the model, and iteratively adjusting parameters of the model until a score generated by the model matches a ground truth score associated with the training item (or another condition is met). In certain embodiments, the scoring engine 220 comprises a Robustly Optimized Bidirectional Encoder Representations from Transformer (BERT) Pretraining Approach (RoBERTa) model.

The feedback items 212A-D and the extracted topics 240 may be provided as part of an input to matching engine 230. Matching engine 230 may comprise a machine learning model, such as an LLM, that is trained and/or otherwise configured to generate an output that indicates a topic that corresponds to each feedback item. As an example, feedback item 212A may comprise user feedback that states “the layout of the home page is too confusing.” Topic 242A may be “home page layout.” When provided with feedback item 212A and topic 242A, matching engine 230 may generate an output that indicates that feedback item 212A corresponds to topic 242A. Based on the output, it may be determined that feedback item 212A corresponds to topic 242A. The matching engine 230 may be trained through a supervised learning process involving training data comprising training topics, training items, and labels indicating topics to which the training items correspond. Parameters of the matching engine 230 may be iteratively adjusted based on a variance between an output generated by the matching engine 230 and the labels (e.g., until the topics indicated in the output match the topics indicated by the labels).

In alternate embodiments, topics and feedback items may be matched based on creating embedding representations of the topics and feedback items. An embedding generally refers to a vector representation of an entity that represents the entity as a vector in n-dimensional space such that similar entities are represented by vectors that are close to one another in the n-dimensional space. The matching engine 230 may comprise an embedding model in some embodiments. The embedding model may comprise a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Jena AI, Word2Vec, and GloVe embeddings. These are included as examples, and other techniques for generating embedding representations of entities are possible.

The matching engine 230 may further comprise a computing component that is configured to perform a semantic similarity comparison involving embeddings. This comparison may be performed by calculating the dot product between two embedding vectors, determining the cosine similarity, Jaccard similarity, Euclidean distance, or Levenshtein distance between two embedding vectors, or using other types of semantic similarity algorithms. The matching engine 230 may use one of these semantic similarity algorithms to compare the topic embeddings with the feedback item embeddings. Each feedback item may be matched with the topic that is determined to be most semantically similar to the feedback item.

After the feedback items 212A-D have been matched to a topic 242, the topics 242A-B may be provided to a score aggregation component 250. The score aggregation component 250 may comprise a computing component that is configured to aggregate the scores for the feedback items that were matched to a topic to generate an aggregated score for the topic. For example, the score aggregation component 250 may calculate a score for a topic based on the median score for all feedback items associated with the topic, the average score for all feedback items associated with the topic, the standard deviation scores for all feedback items associated with the topic, and/or the like. As shown in FIG. 2, feedback items 212A and 212C have been matched to topic 242A. The aggregated score for topic 242A may, for example, be the average sentiment score of feedback items 212A and 212C.

### Example Feedback-To-Topic Mapping

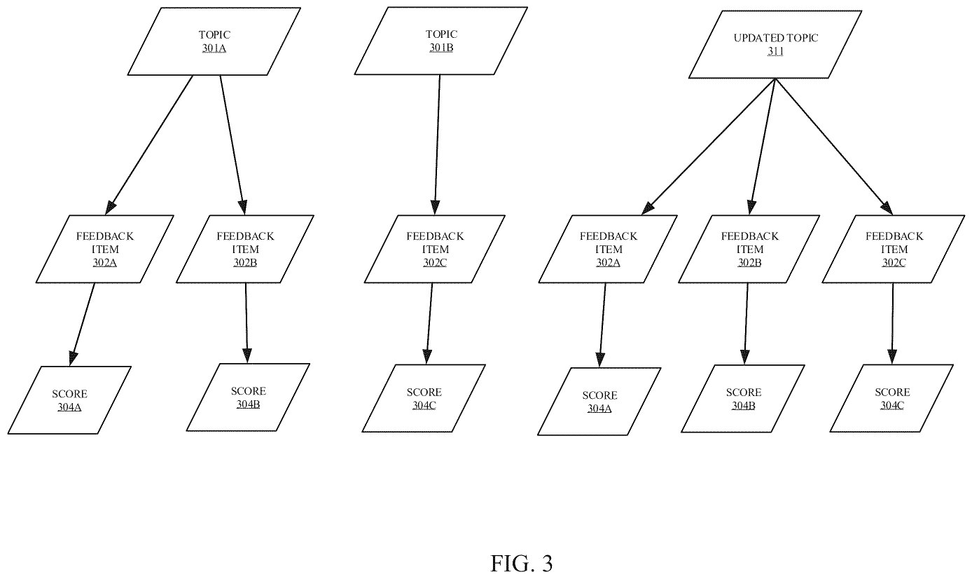

FIG. 3 depicts an example of a feedback-to-topic mapping according to certain embodiments.

As shown in FIG. 3, feedback items 302A and 302B have been matched with topic 301A. Feedback item 302C has been matched with topic 301B. Topic 301A may have been extracted from a group of feedback items (e.g., a group comprising feedback items 302A and 302B) by topic extraction model 200 of FIG. 2. Topic 301B may have been extracted from a group of feedback items received at a later date and/or time (e.g., a group comprising feedback item 302C). The matching may be based on the output of matching engine 230 as described above with respect to FIG. 2.

As an example, feedback items 302A and 302B may be feedback relating to the home screen layout for a website. Topic 301A may be “home page layout.” Topic 301B may be “home screen layout,” a similar topic corresponding to feedback items from a different period of time (e.g., a few days after feedback items 302A and 302B were received).

Feedback item 302A may be given a score 304A, such as by scoring engine 220 of FIG. 2. Feedback item 302B may be given score 304B and feedback item 302C may be given score 304C. Each of the scores may represent a level of user satisfaction associated with the respective feedback item. For instance, if feedback item 302A contains negative feedback, score 304A may be relatively low, whereas if feedback item 304B contains positive feedback, score 304B may be relatively high (or vice versa, e.g., low scores may correspond to positive feedback and high scores correspond to negative feedback). The aggregate score for topic 301A may be based on scores 304A and 304B, as well as scores for any other feedback items matched to topic 301A. The aggregate score for topic 301B may be based on scores 304C and scores for any other feedback items matched to topic 301B.

In some embodiments, embedding representations of the topics may be created (e.g., using an embedding model). After topic 301B is extracted, the embedding representation of topic 301B may be created and compared to embedding representations of other topics that were previously extracted, such as by using a semantic similarity algorithm. Topic 301B may be merged with a topic that is most similar to topic 301B. Alternatively, if no topic has a similarity level relative to topic 301B that exceeds a threshold, topic 301B may be treated as a new topic and not merged with another topic.

As shown in FIG. 3, topic 301B and topic 301A were merged to form updated topic 311. Thus, all of feedback items 302A-C may be matched to updated topic 311. An aggregate score for updated topic 311 may be based on scores 304A-C (e.g., the aggregate score may comprise the average of scores 304A-C, and/or a representation of the scores as a function of time). Topics 301A and 301B may have been merged to form updated topic 311 based on the semantic similarity of the topics. As discussed in the example above, topic 301A may be “home page layout,” and topic 301B may be “home screen layout.” The semantic similarity of these two topics may be greater than a threshold amount, and thus the topics may be determined to have the same meaning despite slightly different wording. As a result, the topics may be merged such that all feedback items relating to the home screen/page layout are associated with the same topic.

Merging topics may allow for the creation of time series data. For example, topics from different time periods (e.g., days, weeks, months, years, and/or the like) may be merged into a single topic and the aggregate score for the topic may be represented as a function of time (e.g., the scores may be represented in a chart, graph, and/or the like). As discussed in the example above, scores 304A and 304B may correspond to feedback items received in a first period of time, and score 304C may correspond to a feedback item received at a later period of time. For example, scores 304A and 304B may represent the scores for feedback items received on the first day, and score 304C may represent the score for the feedback item received on the second day.

Trends in the time series data may be analyzed. For example, if the score of feedback for a topic is trending in a negative direction or positive direction, a user of the feedback analysis system may be notified. Users of the feedback analysis system may also search through the topics, for example, by searching for topics that are most positive/negative, searching for topics that are trending positive/negative, searching for topics by name and/or words within the topic, and/or the like. For example, a search may comprise an embedding vector search involving comparing an embedding representation of search terms to embedding representations of topics. The users may be presented with identified topics and an indication of the level of satisfaction corresponding to the identified topics via a user interface. Actions may be performed based on the scores, such as intervening to correct issues indicated by the feedback when a score is low or declining. As another example, high scores/positive score trends may be used to identify features that satisfy users and implement further changes based on the features.

According to some embodiments, A/B testing and/or other forms of testing may be performed using the scores and/or time series data. For example, two versions of a software application may be deployed, and user feedback may be received with respect to each version. The version with the highest satisfaction score (and/or a better trend in satisfaction score) may be chosen in the test and implemented for all users. As another example, if a relatively small amount of feedback has been received with respect to a first version relative to a second version, the first version may be implemented with more users in order to receive more feedback so that the first version can be accurately evaluated. Thus, embodiments of the present disclosure allow for automated A/B testing.

In certain embodiments, feedback items may be pre-processed to remove irrelevant keywords and/or key phrases, such as words and phrases that do not help with determining satisfaction or extracting topics. For example, some words, such as names, may be too specific to a given user and thus not helpful in determining satisfaction or identifying a topic. As another example, other words may be too general to provide any useful insights. A list of keywords may be provided, and a computing component that is configured to remove keywords may automatically identify and remove the keywords from received feedback items.

### Example Operations Related to Automated Feedback Analysis

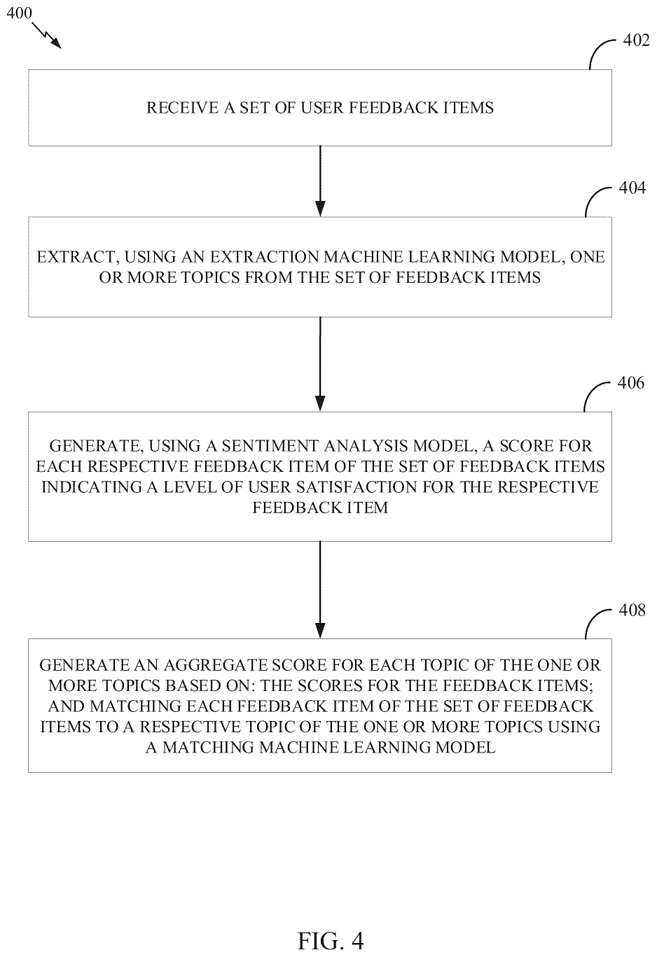

FIG. 4 depicts example operations 400 related to automated feedback analysis. For example, operations 400 may be performed by one or more of the components described with respect to FIG. 1 and FIG. 2.

Operations 400 begin at step 402 with receiving a set of user feedback items.

Operations 400 continue at step 404 with extracting, using an extraction machine learning model, one or more topics from the set of feedback items. In certain embodiments, the extraction machine learning model comprises a large language model (LLM) that has been trained to generate a list of topics based on a given set of feedback items. According to some embodiments, the extracting is based on identifying and removing keywords from the feedback items.

Operations 400 continue at step 406 with generating, using a sentiment analysis model, a score for each respective feedback item of the set of feedback items indicating a level of user satisfaction for the respective feedback item.

Operations 400 continue at step 408 with generating an aggregate score for each topic of the one or more topics based on: the scores for the feedback items; and matching each feedback item of the set of feedback items to a respective topic of the one or more topics using a matching machine learning model. Certain embodiments provide that the matching machine learning model comprises an LLM that has been trained to generate an output that indicates a topic to which a given feedback item corresponds. In some embodiments, the matching machine learning model comprises an embedding model that is used to generate embedding representations of the feedback items and the one or more topics, wherein the matching is based on a semantic similarity comparison involving the embedding representations of the feedback items and the embedding representations of the one or more topics.

According to some embodiments, operations 400 further comprise receiving a set of additional user feedback items; extracting, using the extraction machine learning model, an additional topic from the set of additional feedback items; identifying a given topic of the one or more topics that matches the additional topic based on a semantic similarity comparison involving an embedding representation of the additional topic and an embedding representation of the given topic; and updating the aggregate score for the identified given topic based on feedback items associated with the additional topic. In some embodiments, the updating is based on generating, using the sentiment analysis model, scores for feedback items associated with the additional topic.

Certain embodiments provide that one or more actions may be performed based on the aggregate score. For example, interventions may be made based on low scores and/or negative trends, whereas features associated with high scores and positive trends may be identified and further implemented.

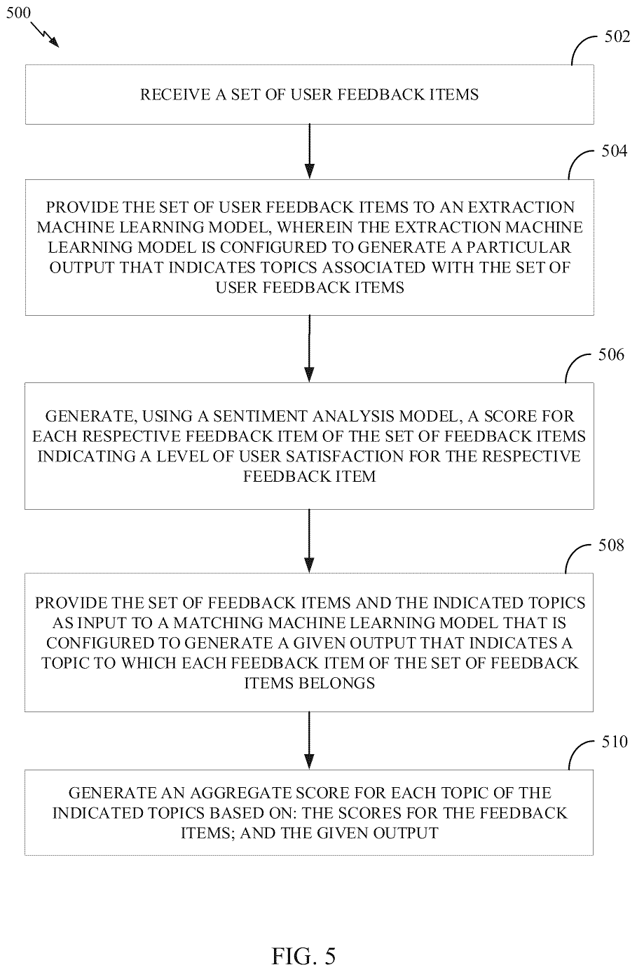

FIG. 5 depicts example operations 500 related to automated feedback analysis. For example, operations 500 may be performed by one or more of the components described with respect to FIG. 1 and FIG. 2.

Operations 500 begin at step 502 with receiving a set of user feedback items.

Operations 500 continue at step 504 with providing the set of user feedback items to an extraction machine learning model, wherein the extraction machine learning model is configured to generate a particular output that indicates topics associated with the set of user feedback items. In certain embodiments, the extraction machine learning model comprises a large language model (LLM) that has been trained to generate a list of topics based on a given set of feedback items.

Operations 500 continue at step 506 with generating, using a sentiment analysis model, a score for each respective feedback item of the set of feedback items indicating a level of user satisfaction for the respective feedback item.

Operations 500 continue at step 508 with providing the set of feedback items and the indicated topics as input to a matching machine learning model that is configured to generate a given output that indicates a topic to which each feedback item of the set of feedback items belongs. Some embodiments provide that the matching machine learning model comprises an LLM that has been trained to generate an output that indicates a topic to which a given feedback item corresponds.

Operations 500 continue at step 510 with generating an aggregate score for each topic of the indicated topics based on: the scores for the feedback items; and the given output.

According to some embodiments, operations 500 further comprise receiving a set of additional user feedback items; extracting, using the extraction machine learning model, an additional topic from the set of additional feedback items; identifying a given topic of the one or more topics that matches the additional topic based on a semantic similarity comparison involving an embedding representation of the additional topic and an embedding representation of the given topic; and updating the aggregate score for the identified given topic based on feedback items associated with the additional topic. In some embodiments, the updating is based on generating, using the sentiment analysis model, scores for feedback items associated with the additional topic.

### Example of a Processing System for Automated Feedback Analysis

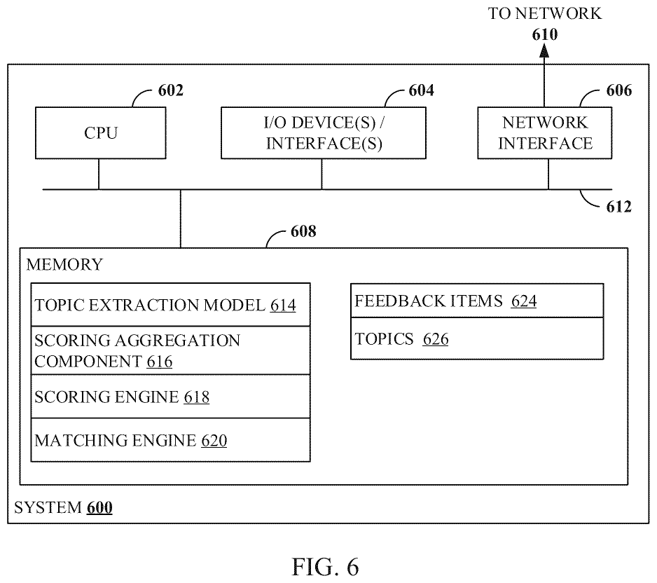

FIG. 6 illustrates an example system 600 with which embodiments of the present disclosure may be implemented. For example, system 600 may be configured to perform operations 400 of FIG. 4 or operations 500 of FIG. 5 and/or to implement one or more components as in FIG. 1 or FIG. 2.

System 600 includes a central processing unit (CPU) 602, one or more I/O device interfaces that may allow for the connection of various I/O devices 604 (e.g., keyboards, displays, mouse devices, pen input, etc.) to the system 600, network interface 606, a memory 608, and an interconnect 612. It is contemplated that one or more components of system 600 may be located remotely and accessed via a network 610. It is further contemplated that one or more components of system 600 may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes topic extraction model 614, score aggregation component 616, scoring engine 618, and matching engine 620. Topic extraction model 614 may be representative of topic extraction model 200 of FIG. 2. In some embodiments, score aggregation component 616 may be representative of score aggregation component 250 of FIG. 2. Scoring engine 618 may be representative of scoring engine 220 of FIG. 2. Matching engine 620 may be representative of matching engine 230 of FIG. 2.

Memory 608 further comprises feedback items 624, which may correspond to feedback items 212A-D of FIG. 2 or feedback items 302A-C of FIG. 3. Memory 608 further comprises topics 626 which may correspond to topics 242A-B of FIG. 2 as well as topics 301A-B or updated topic 311 FIG. 3.

It is noted that in some embodiments, system 600 may interact with one or more external components, such as via network 610, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automated feedback analysis, comprising:
receiving a set of user feedback items;
extracting, using an extraction machine learning model, one or more topics from the set of feedback items;
generating, using a sentiment analysis model, a score for each respective feedback item of the set of feedback items indicating a level of user satisfaction for the respective feedback item; and
generating an aggregate score for each topic of the one or more topics based on:
the scores for the feedback items; and
matching each feedback item of the set of feedback items to a respective topic of the one or more topics using a matching machine learning model.

2. The method of claim 1, further comprising:
receiving a set of additional user feedback items;
extracting, using the extraction machine learning model, an additional topic from the set of additional feedback items;
identifying a given topic of the one or more topics that matches the additional topic based on a semantic similarity comparison involving an embedding representation of the additional topic and an embedding representation of the given topic; and
updating the aggregate score for the identified given topic based on feedback items associated with the additional topic.

3. The method of claim 2, wherein the updating is based on generating, using the sentiment analysis model, scores for feedback items associated with the additional topic.

4. The method of claim 1, wherein the extraction machine learning model comprises a large language model (LLM) that has been trained to generate a list of topics based on a given set of feedback items.

5. The method of claim 1, wherein the matching machine learning model comprises an LLM that has been trained to generate an output that indicates a topic to which a given feedback item corresponds.

6. The method of claim 1, wherein the matching machine learning model comprises an embedding model that is used to generate embedding representations of the feedback items and the one or more topics, wherein the matching is based on a semantic similarity comparison involving the embedding representations of the feedback items and the embedding representations of the one or more topics.

7. The method of claim 1, wherein the extracting is based on identifying and removing keywords from the feedback items.

8. The method of claim 1, further comprising performing one or more actions based on the aggregate score.

9. A method of automated feedback analysis, comprising:
receiving a set of user feedback items;
providing the set of user feedback items to an extraction machine learning model, wherein the extraction machine learning model is configured to generate a particular output that indicates topics associated with the set of user feedback items;
generating, using a sentiment analysis model, a score for each respective feedback item of the set of feedback items indicating a level of user satisfaction for the respective feedback item;
providing the set of feedback items and the indicated topics as input to a matching machine learning model that is configured to generate a given output that indicates a topic to which each feedback item of the set of feedback items belongs; and
generating an aggregate score for each topic of the indicated topics based on:
the scores for the feedback items; and
the given output.

10. The method of claim 9, further comprising:
receiving a set of additional user feedback items;
extracting, using the extraction machine learning model, an additional topic from the set of additional feedback items;
identifying a given topic of the indicated topics that matches the additional topic based on a semantic similarity comparison involving an embedding representation of the additional topic and an embedding representation of the given topic; and
updating the aggregate score for the identified given topic based on feedback items associated with the additional topic.

11. The method of claim 10, wherein the updating is based on generating, using the sentiment analysis model, scores for feedback items associated with the additional topic.

12. The method of claim 9, wherein the extraction machine learning model comprises a large language model (LLM) that has been trained to generate a list of topics based on a given set of feedback items.

13. The method of claim 9, wherein the matching machine learning model comprises an LLM that has been trained to generate an output that indicates a topic to which a given feedback item corresponds.

14. A system for automated feedback analysis, comprising:
one or more processors; and
a memory comprising instructions that, when executed by the one or more processors, cause the system to:
receive a set of user feedback items;
extract, using an extraction machine learning model, one or more topics from the set of feedback items;
generate, using a sentiment analysis model, a score for each respective feedback item of the set of feedback items indicating a level of user satisfaction for the respective feedback item; and
generate an aggregate score for each topic of the one or more topics based on:
the scores for the feedback items; and
matching each feedback item of the set of feedback items to a respective topic of the one or more topics using a matching machine learning model.

15. The system of claim 14, wherein the instructions further cause the system to:
receive a set of additional user feedback items;
extract, using the extraction machine learning model, an additional topic from the set of additional feedback items;
identify a given topic of the one or more topics that matches the additional topic based on a semantic similarity comparison involving an embedding representation of the additional topic and an embedding representation of the given topic; and
update the aggregate score for the identified given topic based on feedback items associated with the additional topic.

16. The system of claim 15, wherein the updating is based on generating, using the sentiment analysis model, scores for feedback items associated with the additional topic.

17. The system of claim 14, wherein the extraction machine learning model comprises a large language model (LLM) that has been trained to generate a list of topics based on a given set of feedback items.

18. The system of claim 14, wherein the matching machine learning model comprises an LLM that has been trained to generate an output that indicates a topic to which a given feedback item corresponds.

19. The system of claim 14, wherein the matching machine learning model comprises an embedding model that is used to generate embedding representations of the feedback items and the one or more topics, wherein the matching is based on a semantic similarity comparison involving the embedding representations of the feedback items and the embedding representations of the one or more topics.

20. The system of claim 14, wherein the extracting is based on identifying and removing keywords from the feedback items.
